(19) United States
(12) Patent Application Publication
(10) Pub. No.: US 2013/0099906 A1
(43) Pub. Date: Apr. 25, 2013

(54) REMOTE CONTROLLER SWITCHING DEVICE

(71) Applicants: KUO-CHAN PENG, PINGZHEN CITY (TW); CHING-FENG HSIEH, TAIPEI CITY (TW)

(72) Inventors: KUO-CHAN PENG, PINGZHEN CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/297,610

(22) Filed: Nov. 16, 2011

(30) Foreign Application Priority Data
Oct. 21, 2011 (TW) 100138338

(51) Int. Cl. G05B 11/01

(52) U.S. Cl. 340/12.55

(57) ABSTRACT

A remote controller switching device is used with a smart handheld electronic device installed with a control program providing a remote controller interface. When manipulated, the remote controller interface allows the control program to generate an operation instruction for controlling remotely an intended target. The remote controller switching device includes a fixation base for fixing the smart handheld electronic device in place, and a remote control module having a transmission connection portion and a protocol portion. After creating a transmission connection to the smart handheld electronic device, the remote controller switching device generates a remote control signal based on the operation instruction to control the intended target remotely through the protocol portion.

### CROSS-REFERENCE TO RELATED APPLICATION

This non-provisional application claims priority under 35 U.S.C. §119(a) on Patent Application No(s). 100138338 filed in Taiwan, R.O.C. on Oct. 21, 2011, the entire contents of which are hereby incorporated by reference.

### FIELD OF TECHNOLOGY

The present invention relates to remote controller switching devices, and more particularly, to a remote controller switching device for use with smart handheld electronic devices.

### BACKGROUND

Due to the convenience brought by remote control technology, electric appliances nowadays rely increasingly upon remote controllers in order to be capable of being remotely controlled. Users in possession of remote controllers increase with the electric appliances capable of being remotely controlled. However, a plethora of remote controllers poses management issues inevitably.

Hence, a universal remote controller was designed to function as a single remote controller for replacing multiple remote controllers operating together, and was aimed at streamlining management and usage of the conventional universal remote controller. However, the conventional universal remote controller has its drawbacks, namely high production costs, and a likelihood that the conventional universal remote controller is unable to support a new electric appliance due to a mismatch of functions.

### SUMMARY

It is an objective of the present invention to provide a remote controller switching device for switching the functionality and use of a smart handheld electronic device to the functionality and use of a remote controller directly.

In order to achieve the above and other objectives, the present invention provides a remote controller switching device for use with a smart handheld electronic device loaded with a control program providing a remote controller interface. The remote controller switching device comprises a fixation base and a remote control module. The fixation base is for fixing the smart handheld electronic device in place. The remote control module is disposed on the fixation base and has a transmission connection portion and a protocol portion electrically connected to the transmission connection portion. The transmission connection portion creates transmission-oriented connection with the smart handheld electronic device for controlling the remote controller interface. An operation instruction is generated by the control program accordingly and received by the transmission connection portion. The protocol portion generates a remote control signal based on the operation instruction to exercise remote control over at least an intended target.

In an embodiment, the remote control module further comprises an image sensing portion electrically connected to the transmission connection portion for capturing an image to produce a subject image data, wherein an image data related to at least an intended target and a manipulating data attributed to the at least an intended target are stored in the smart handheld electronic device, and the smart handheld electronic device compares the image data stored and related to the at least an intended target with the received subject image data to determine the recognized intended target and defines the remote controller interface based on a manipulating data attributed to the at least an intended target.

In an embodiment, the image sensing portion is a charge-coupled device (CCD) or a complementary metal-oxide-semiconductor (CMOS).

In an embodiment, the image sensing portion and the protocol portion are disposed on a lateral side of the fixation base such that the image sensing portion and the protocol portion face the same direction.

Accordingly, with a means of switching, a user uses a smart handheld electronic device as a remote controller. A remote controller switching device of the present invention features low production costs and ease of expansion of support given to remote controllers. The expansion of support is carried out by updating a control program loaded on the smart handheld electronic device. The support is also expanded easily by storing an image data related to at least an intended target and a manipulating data. Therefore, integration of the remote controller switching device and the smart handheld electronic device adds to the diverse ways of operating a remote controller and the ease of use thereof.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic view of a remote controller switching device and a smart handheld electronic device coupled thereto in an embodiment of the present invention;

FIG. 2 is a functional block diagram of a remote controller switching device and a smart handheld electronic device coupled thereto in an embodiment of the present invention;

FIG. 3 is a functional block diagram of a remote controller switching device and a smart handheld electronic device coupled thereto in another embodiment of the present invention; and

FIG. 4 is a schematic view of a remote controller switching device and a smart handheld electronic device coupled thereto in another embodiment of the present invention.

### DETAILED DESCRIPTION

Due to the rapid development of smart handheld electronic devices, such as smartphones and portable personal digital assistants (PDA), and the advancement of the semiconductor industry, smart handheld electronic devices nowadays have increasingly powerful and diverse functions and process data at an ever-increasing speed. In the embodiments of the present invention, a smart handheld electronic device can be used as a remote controller by means of a remote controller switching device of present invention.

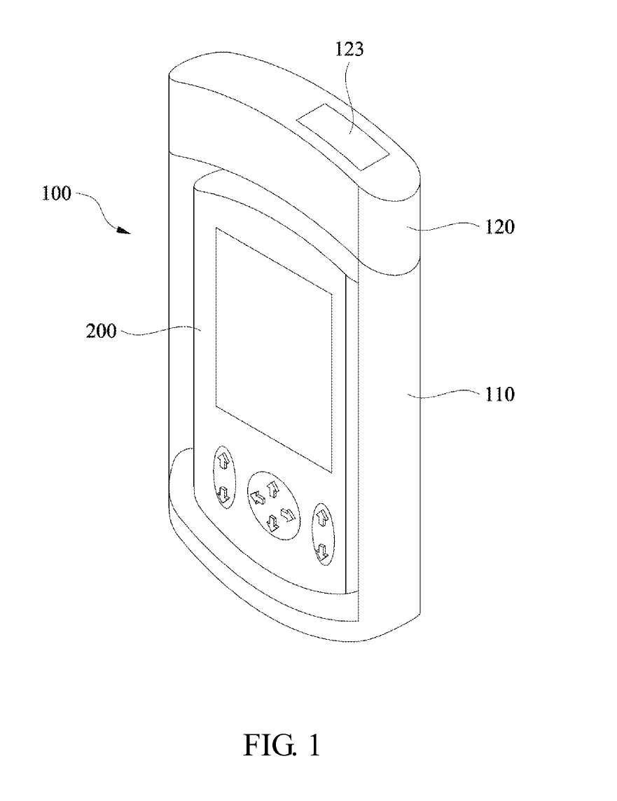

Referring to FIG. 1, there is shown a schematic view of a remote controller switching device 100 and a smart handheld electronic device 200 coupled thereto in an embodiment of the present invention. As shown in FIG. 1, the remote controller switching device 100 comprises a fixation base 110 and a remote control module 120. The fixation base 110 is for fixing the smart handheld electronic device 200 in place. The smart handheld electronic device 200 is fixed to the fixation base 110 by snap-engagement. Various means of implementing snap-engagement can be readily accomplished by persons skilled in the prior art and thus are not described in detail herein for the sake of brevity.

The remote control module 120 and the fixation base 110 are mutually fixed to each other. The remote control module 120 and the fixation base 110 together serve as a bridge of transmission of a remote control signal between the smart handheld electronic device 200 and at least an intended target. The smart handheld electronic device 200 is loaded (installed) with a control program of a remote controller interface, such as an App program. By manipulating the remote controller interface, the control program generates an operation instruction accordingly, and then the operation instruction is sent to the remote control module 120 for exercising the remote control of the at least an intended target.

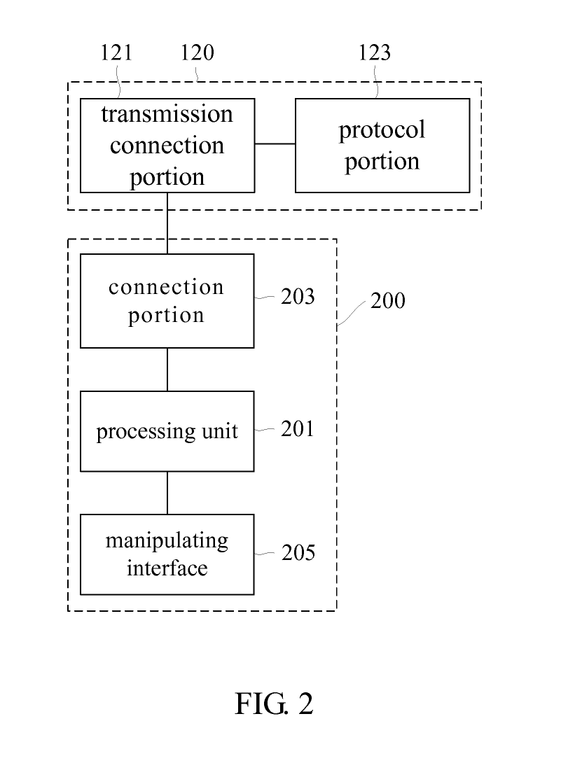

Referring to FIG. 2, there is shown a functional block diagram of a remote controller switching device and a smart handheld electronic device coupled thereto in an embodiment of the present invention. The remote control module 120 comprises a transmission connection portion 121 and a protocol portion 123. The transmission connection portion 121 creates transmission-oriented connection between the remote controller switching device 100 and the smart handheld electronic device 200 for receiving the operation instruction generated by the control program. To be specific, the transmission connection portion 121 creates transmission-oriented connection with a connection portion 203 of the smart handheld electronic device 200. For example, a USB (Universal Serial Bus) port enables wired connection between the transmission connection portion 121 and the connection portion 203 of the smart handheld electronic device 200, and a Bluetooth port enables wireless connection between the transmission connection portion 121 and the connection portion 203 of the smart handheld electronic device 200.

The protocol portion 123 is provided in the form of any infrared emission module in general; alternatively, a Bluetooth emission module or any appropriate radio emission module is applicable to the present invention.

In practice, operation of the remote controller switching device 100 requires following the steps of: fixing the smart handheld electronic device 200 to the fixation base 110 of the remote controller switching device 100; confirming by the control program of the smart handheld electronic device 200 whether data transmission between the smart handheld electronic device 200 and the transmission connection portion 121 is functioning well; displaying a manipulating interface 205 of a selected remote controller on a touchscreen of the smart handheld electronic device 200 by the control program; sending, by user's manipulation, the operation instruction generated by the control program to the transmission connection portion 121; generating the remote control signal by the protocol portion 123 electrically connected to the transmission connection portion 121; and exercising remote control over the at least an intended target according to the remote control signal so as to achieve the goal of using the smart handheld electronic device 200 as a remote controller.

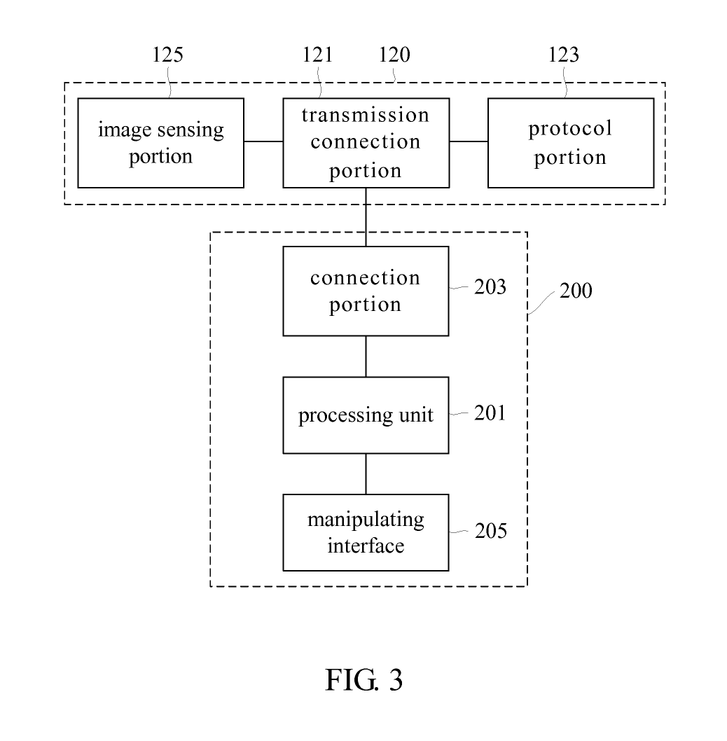

Referring to FIG. 3, there is shown a functional block diagram of a remote controller switching device and a smart handheld electronic device coupled thereto in another embodiment of the present invention. In this embodiment, the remote control module 120 further comprises an image sensing portion 125. The image sensing portion 125 is connected to the transmission connection portion 121, controlled by the control program, and adapted to capture an image for producing a subject image data.

An image data related to at least an intended target and a manipulating data attributed to the at least an intended target are stored in the smart handheld electronic device 200 in advance. In practice, with the smart handheld electronic device 200, a user controls the image sensing portion 125 for capturing the image to produce the subject image data. Then, the subject image data is sent to a processing unit 201 of the smart handheld electronic device 200 through the transmission connection portion 121 and the connection portion 203 of the smart handheld electronic device 200. Afterward, the processing unit 201 compares the image data stored and related to the at least an intended target with the received subject image data to determined the recognized intended target. Furthermore, the processing unit 201 defines the remote controller interface based on a manipulating data attributed to the at least an intended target. Finally, the manipulating interface 205 corresponding to the recognized intended target is display on the touchscreen of the smart handheld electronic device 200.

The image sensing portion 125 is a charge-coupled device (CCD), a complementary metal-oxide-semiconductor (CMOS), or the like.

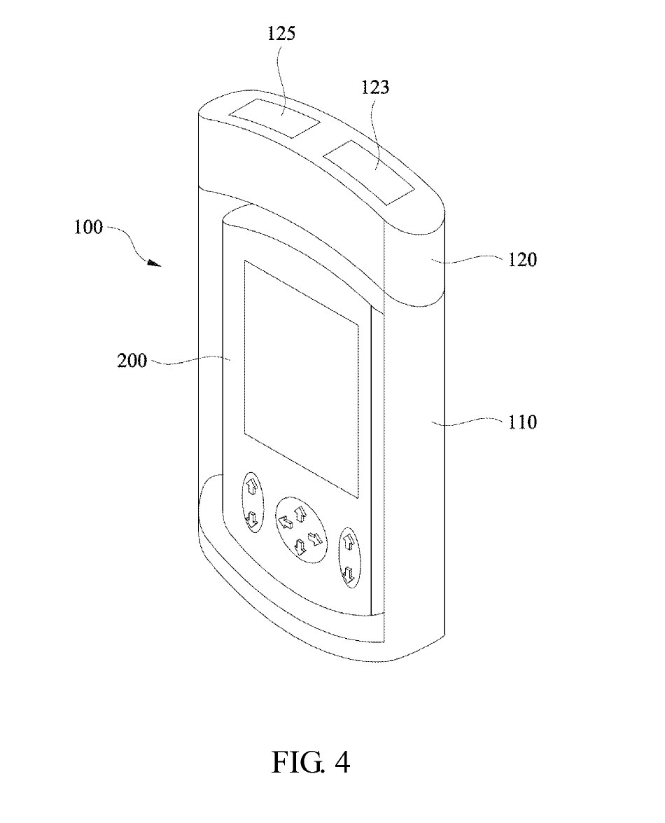

As shown in FIG. 4, in a preferred embodiment, the image sensing portion 125 and the transmission connection portion 121 are disposed on a lateral side of the remote controller switching device 100 (for example, at the front end of the remote control module 120 in FIG. 1) in a manner that the image sensing portion 125 and the transmission connection portion 121 face the same direction. Hence, the user can point the remote controller switching device 100 (to which the smart handheld electronic device 200 is coupled) at an intended target and capture images (by key or by any appropriate means) conveniently without the hassles of turning over the remote controller switching device 100.

In conclusion, with a means of switching, a user uses a smart handheld electronic device as a remote controller. A remote controller switching device of the present invention features low production costs and ease of expansion of support given to remote controllers. The expansion of support is carried out by updating a control program loaded on the smart handheld electronic device. The support is also expanded easily by storing an image data related to at least an intended target and a manipulating data. Ease of use is enhanced by a further advantage of the remote controller switching device of the present invention, that is, all the user has to do is to point the remote controller switching device at an intended target and capture images thereof.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A remote controller switching device for use with a smart handheld electronic device loaded with a control program providing a remote controller interface, the remote controller switching device comprising:
a fixation base for fixing the smart handheld electronic device in place; and
a remote control module disposed on the fixation base and having a transmission connection portion and a protocol portion electrically connected to the transmission connection portion, the transmission connection portion creating transmission-oriented connection with the smart handheld electronic device for controlling the remote controller interface, wherein an operation instruction is generated by the control program accordingly and received by the transmission connection portion, and the protocol portion generates a remote control signal based on the operation instruction to exercise remote control over at least an intended target.

2. The remote controller switching device of claim 1, wherein the remote control module further comprises an image sensing portion connected to the transmission connection portion for capturing an image to produce a subject image data, wherein an image data related to the at least an intended target and a manipulating data attributed to the at least an intended target are stored in the smart handheld electronic device, wherein the smart handheld electronic device compares the image data stored and related to the at least an intended target with the received subject image data to determine the recognized intended target and defines the remote controller interface based on a manipulating data attributed to the at least an intended target.

3. The remote controller switching device of claim 2, wherein the image sensing portion the image sensing portion is one of a charge-coupled device (CCD) and a complementary metal-oxide-semiconductor (CMOS).

4. The remote controller switching device of claim 2, wherein the image sensing portion and the protocol portion are disposed on a lateral side of the fixation base such that the image sensing portion and the protocol portion face a same direction.
